(19) United States
(12) Patent Application Publication
(10) Pub. No.: US 2025/0089743 A1
(43) Pub. Date: Mar. 20, 2025

(54) BEVERAGE COMPOSITION FOR RECOVERING FROM AND REDUCING MUSCULAR FATIGUE

(71) Applicant: AUNO CO., LTD., Yeongcheon-si, Gyeongsangbuk-do (KR)

(72) Inventor: Jae Won KWON, Yeongcheon-si, Gyeongsangbuk-do (KR)

(21) Appl. No.: 18/729,568

(22) PCT Filed: Jun. 29, 2023
(86) PCT No.: PCT/KR2023/009144

§ 371 Date: Jul. 17, 2024

(30) Foreign Application Priority Data
Nov. 30, 2022 (KR) 10-2022-0163933

(51) Int. Cl. A23L 2/38; A23L 2/02; A23L 19/10; A23L 33/175

(52) U.S. Cl. CPC A23L 2/38; A23L 2/02; A23L 19/10; A23L 33/175

(57) ABSTRACT

Embodiments relate to a beverage composition for recovering from and reducing muscular fatigue. Proposed in one embodiment is the beverage composition for recovering from and reducing muscular fatigue, wherein the beverage composition comprises 10-25 wt % of sugarcane juice, 60-90 wt % of natural herbal ingredients, 5-15 wt % of functional amino acid ingredients and the remainder.

### TECHNICAL FIELD

The present invention relates to a beverage composition for recovering from and reducing muscular fatigue, more specifically, to a beverage composition for professional athletes, which enables to recover from and reduce muscular fatigue by improving the ability to decompose lactic acid before and after exercise and has improved sensory properties such as taste and ease of intake.

### BACKGROUND ART

Professional athletes in sports that require consumption of a lot of energy, such as soccer or basketball, take in powder or syrup-type beverages before or during the game to reduce muscular fatigue. These beverage products contain various chemical additives, which may cause side effects such as allergies. Therefore, it is necessary to develop a beverage composition that contains natural substances that do not cause allergic side effects.

Here, muscular fatigue refers to a state where the ability to perform physical activity is temporarily decreased after high-intensity exercise or long-term exercise, and it is accompanied by a decrease in muscle contractility, and the like. Muscular fatigue causes muscle pain when lactic acid accumulates in the muscles after exercise.

Meanwhile, exercise performance ability refers to the ability to perform physical movements performed in daily life or sports quickly, intensively, for a long time, and skillfully. Factors affecting this exercise performance ability vary depending on the type of exercise and physical movement, and can be divided into muscle fatigue recovery, endurance, and neuromuscular activation.

Improving exercise performance is considered as having a beneficial physiological effect even on people who perform routine physical activities that are not related to exercise. In addition, reducing muscular fatigue is also considered as having a beneficial physiological effect on the performance of exercise.

Therefore, there is a need to develop a beverage composition that can improve exercise performance ability by enabling to recover from and reduce muscular fatigue for professional athletes and that is also easy to ingest.

### DETAILED DESCRIPTION OF THE INVENTION

### Technical Problem

The technical objective to be achieved by the present invention is to provide a beverage composition for professional athletes, which enables to recover from and reduce muscular fatigue by improving the ability to decompose lactic acid before and after exercise and has improved sensory properties such as taste and ease of intake.

More specifically, the technical objective to be achieved by the present invention is to provide a functional beverage composition having high mineral content and amino acid content, and excellent antioxidant capacity, exercise ability improving effect, and sensory properties.

The technical objectives to be achieved by the present invention are not limited to the above-mentioned technical objectives, and other technical objectives not mentioned can be clearly understood from the description below by one of ordinary skill in the art to which the present invention pertains.

### Technical Solution

In order to achieve the purposes described, one embodiment of the present invention provides a beverage composition for recovering from and reducing muscular fatigue, including 10% to 25% by weight of sugarcane juice, 60% to 90% by weight of natural herbal ingredients, 5% to 15% by weight of functional amino acid ingredients, and the remainder.

In one embodiment of the present invention, the natural herbal ingredients may include 30% to 60% by weight of plum extract, 5% to 20% by weight of Schisandra chinensis extract, 5% to 20% by weight of black raspberry extract, and 1% to 5% by weight of red ginseng.

In one embodiment of the present invention, the functional amino acid ingredients may include 2% to 7% by weight of branched-chain amino acid (BCAA), 3% to 8% by weight of alanine, and 0.2% to 2% by weight of proline.

In one embodiment of the present invention, the sugarcane juice may be prepared by crushing and drying sugarcane and then forming a juice through vacuum depressurization.

### Advantageous Effects

According to one embodiment of the present invention, a beverage composition for professional athletes, which enables to recover from and reduce muscular fatigue by improving the ability to decompose lactic acid before and after exercise and has improved sensory properties such as taste and ease of intake, can be provided.

In addition, according to one embodiment of the present invention, a functional beverage composition having high mineral content and amino acid content, and excellent antioxidant capacity, exercise ability improving effect, and sensory properties can be provided.

The effects of the present invention are not limited to the above-described effects, and should be understood to include all effects that may be inferred from the detailed description of the present invention or the features of the invention described in the claims.

### DESCRIPTION OF THE DRAWINGS

FIG. 1 shows a table of ingredients of a beverage composition for recovering from and reducing muscular fatigue according to an example of the present invention.

FIG. 2 shows a table of ingredients of a beverage composition of comparative examples compared to an example of the present invention.

FIG. 3 shows a table of mineral content results of the example and comparative examples according to FIGS. 1 and 2.

FIG. 4 shows a table of amino acid content results of the example and comparative examples according to FIGS. 1 and 2.

FIG. 5 shows a table of antioxidant capacity results of the example and comparative examples according to FIGS. 1 and 2.

FIG. 6 shows a table of exercise ability results of the example and comparative examples according to FIGS. 1 and 2.

FIG. 7 shows a table of sensory evaluation results of the example and comparative examples according to FIGS. 1 and 2.

### BEST MODE

Hereinafter, the present invention will be described with reference to the attached drawings. However, the present invention may be implemented in various different forms, and therefore, it is not limited to the embodiments described herein. In addition, in order to clearly describe the present invention in the drawings, parts that are not related to the description are omitted, and similar parts are assigned similar reference numerals throughout the specification.

Throughout the specification, when a part is described to be “connected (linked, contacted, joined)” to another part, this includes not only the case where it is “directly connected” but also the case where it is “indirectly connected” with another member therebetween. Also, when a part is described to “include” a certain component, this does not mean that other components are excluded, unless otherwise specifically stated, but that other components may be included.

The terminology used herein is for the purpose of describing particular embodiments only and is not intended to limit the present invention. An expression used in the singular encompasses the expression of the plural, unless it has a clearly different meaning in the context. In the present specification, it is to be understood that terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The present invention provides a beverage composition for recovering from and reducing muscular fatigue. In addition, the present invention provides a functional beverage composition having high mineral content and amino acid content, and excellent antioxidant capacity, exercise ability improving effect, and sensory properties.

A beverage composition for recovering from and reducing muscular fatigue according to one embodiment of the present invention may include 10% to 25% by weight of sugarcane juice, 60% to 90% by weight of natural herbal ingredients, 5% to 15% by weight of functional amino acid ingredients, and the remainder. Here, the remainder may be salt.

In one embodiment of the present invention, the natural herbal ingredients may include 30% to 60% by weight of plum extract, 5% to 20% by weight of Schisandra chinensis extract, 5% to 20% by weight of black raspberry extract, and 1% to 5% by weight of red ginseng.

In one embodiment of the present invention, the functional amino acid ingredients may include 2% to 7% by weight of branched-chain amino acid (BCAA), 3% to 8% by weight of alanine, and 0.2% to 2% by weight of proline.

In one embodiment of the present invention, the sugarcane juice may be prepared by crushing and drying sugarcane and then forming a juice through vacuum depressurization.

### EXAMPLE

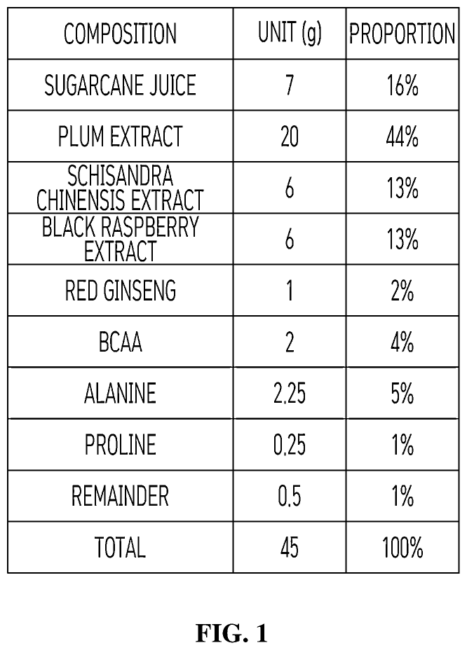

FIG. 1 shows a table of ingredients of a beverage composition for recovering from and reducing muscular fatigue according to an example of the present invention. FIG. 1 shows the unit weight and proportion (% by weight) of each ingredient of the beverage composition.

The beverage composition for recovering from and reducing muscular fatigue according to the present invention may contain sugarcane juice as an effective ingredient. The sugarcane juice may be unrefined sugarcane raw sugar, and may be a molasses-containing sugar that is rich in minerals and antioxidants because it is not centrifuged during the production process.

The sugarcane juice according to an example of the present invention has advantages, compared to the conventional sugarcane sugar, such as reduced foreign substances (removal of 20 g/10 tons of soft foreign substances and 2 g/10 tons of metallic foreign substances), uniform particle size (less than 2.5 mm), and quality maintenance (packaged with moisture content of 3% or less).

The sugarcane juice according to an example of the present invention may contain 93.94 g of carbohydrates, 355.4 mg of potassium, 241.4 mg of calcium, 61.4 mg of magnesium, and 41.5 mg of phosphorus per 100 g of the product.

The sugarcane juice according to an example of the present invention may be produced by a screw device capable of simultaneously crushing and drying sugarcane while transporting it. The screw device may include a rotatable screw main shaft and a blade portion helically mounted on the screw main shaft.

Such a screw device may be installed inside a drying chamber. Hot air may be supplied inside the drying chamber. Accordingly, crushing and drying may be performed simultaneously while transporting sugar cane without undergoing processes such as centrifugation.

### COMPARATIVE EXAMPLES

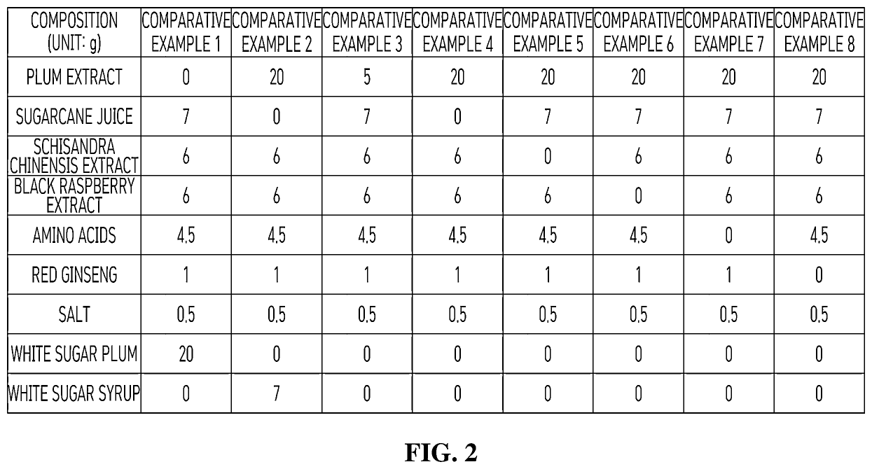

FIG. 2 shows a table of ingredients of a beverage composition of a comparative example compared to an example of the present invention. A total of eight comparative examples were prepared.

Comparative Example 1 included white sugar plum instead of plum extract in comparison with the beverage composition according to the above-described example of the present invention.

Comparative Example 2 included white sugar syrup instead of sugarcane juice in comparison with he beverage composition according to the above-described example of the present invention.

Comparative Examples 3 to 8 were prepared to include a specific ingredient in an excessively high/excessively low content or not to include the specific ingredient in comparison with the example.

### Experimental Results

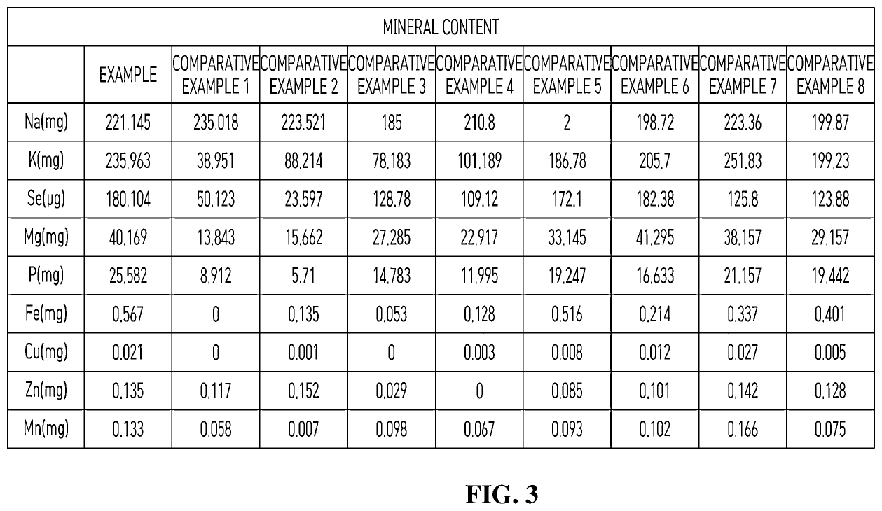

FIG. 3 shows a table of mineral content results of the example and comparative examples according to FIGS. 1 and 2, FIG. 4 shows a table of amino acid content results of the example and comparative examples according to FIGS. 1 and 2, FIG. 5 shows a table of antioxidant capacity results of the example and comparative examples according to FIGS. 1 and 2, FIG. 6 shows a table of exercise ability results of the example and comparative examples according to FIGS. 1 and 2, and FIG. 7 shows a table of sensory evaluation results of the example and comparative examples according to FIGS. 1 and 2.

### Experimental Results: Mineral Content

The mineral content included in the beverage compositions according to the example and comparative examples was analyzed. For example, a small amount of the beverage compositions according to the example and comparative examples was taken, and a mixture prepared by mixing HNO₃ and H₂O₂ therewith was heated using a microwave oven. A 2% to 3% HNO₃ solution was further introduced to the resulting mixture and diluted, and the mineral content was analyzed by inductively coupled plasma (ICP) (Optima 7300 DV, Perkin Elmer, England). The results are shown in the table in FIG. 3 (unit: mg/kg).

According to the results, it can be seen that the total mineral content of the beverage composition according to the example was higher than the mineral content of Comparative Examples 1 to 8, and that all major minerals were included.

### Experimental Results: Amino Acid Content

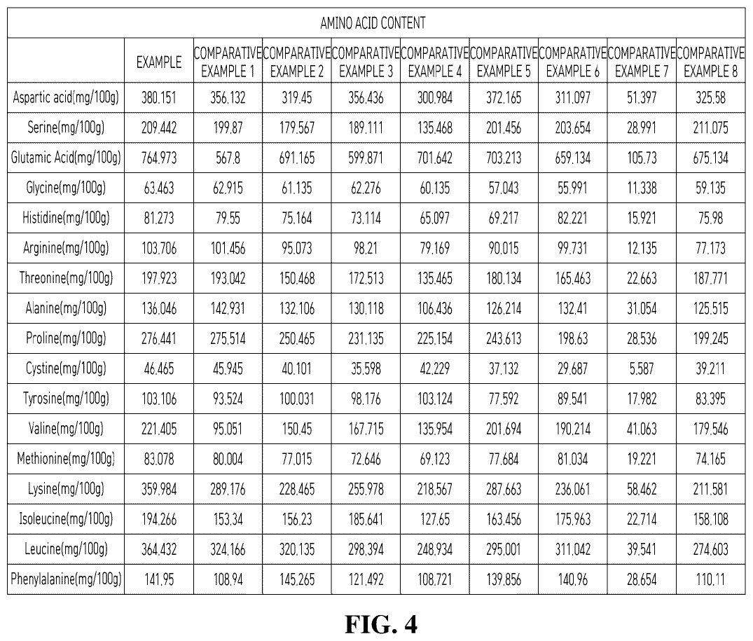

The amino acid content included in the beverage compositions according to the example and comparative examples was analyzed by a known method. Such a known method may be the Pico-Tag method. The results are shown in the table of FIG. 4 (unit: mg/100 g).

According to these results, it can be confirmed that the total amino acid content according to the example was higher than the amino acid content of Comparative Examples 1 to 8, and that all major amino acids were included in an appropriate amount or more.

### Experimental Results: Antioxidant Capacity

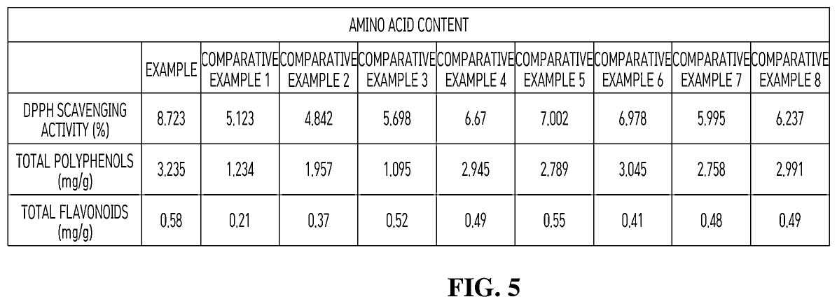

The antioxidant capacity of the beverage compositions according to the example and comparative examples was analyzed by known methods. For example, the 2,2-diphenyl-1-picrylhydrazy (DPPH) radical scavenging activity was measured by adding 150 μL of a DPPH solution to 50 μL of a sample, allowing the resulting mixture to stand at room temperature for about 30 minutes, and then measuring the absorbance at 517 nm. The DPPH radical scavenging activity (%) is expressed as ‘(1−(absorbance of the group with added sample solution/absorbance of the group without added sample solution))×100,’ and ascorbic acid (Sigma, St Louis, MO, USA) was used as a positive control. In addition, the total polyphenol content was measured by mixing 100 μL of Folin-Ciocalteu reagent with 20 μL of a sample, allowing the resulting mixture to stand at room temperature for about 3 minutes, mixing 80 μL of 10% Na₂CO₃, allowing the resulting mixture to stand again at room temperature for about one hour, and then measuring the absorbance at 765 nm using a spectrophotometer. Gallic acid (Sigma Chemical Co.) was used as a reference material. The results are shown in the table in FIG. 5.

According to these results, it can be seen that the beverage composition according to the example has a significantly higher DPPH scavenging activity (%) and higher total polyphenols (mg/g) and total flavonoids (mg/g) than those of the beverage compositions according to the comparative examples.

### Experimental Results: Exercise Ability

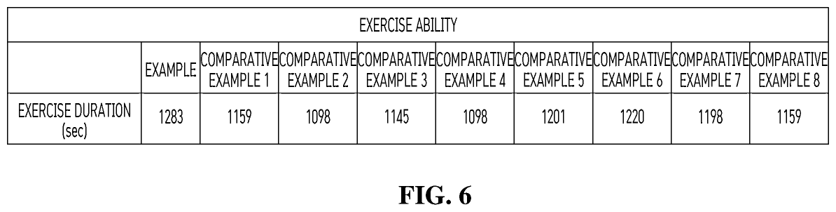

After ingesting the beverage compositions according to the example and comparative examples, the exercise ability was analyzed. The exercise duration (seconds) as the results is shown in FIG. 6.

An example of an exercise program for measuring exercise duration is described below. First, warm-up was done on a treadmill at a speed of 10.1 km/hr for four minutes, at a speed of 11.5 km/hr for two minutes, and then at speeds of 10.1 to 13.0, 10.1 to 14.4, 10.1 to 13.0, and 10.1 to 11.5 km/hr, with intervals of one minute at a high speed and two minutes at a low speed, for a total of 18 minutes.

Thereafter, as the main exercise, according to an interval training protocol, running at 7 km/hr for 1 minute and 5 seconds and at 16 km/hr for 35 seconds was repeated. After ingesting the beverage composition, the interval training protocol was carried out after the same amount of time, and the exercise duration was measured until the subject could no longer maintain the running speed or until the subject requested to stop running.

According to the results, it can be confirmed that the exercise duration was longer when the beverage composition according to the example was ingested compared to the case where the beverage composition according to the comparative examples was ingested.

### Experimental Results: Sensory Evaluation

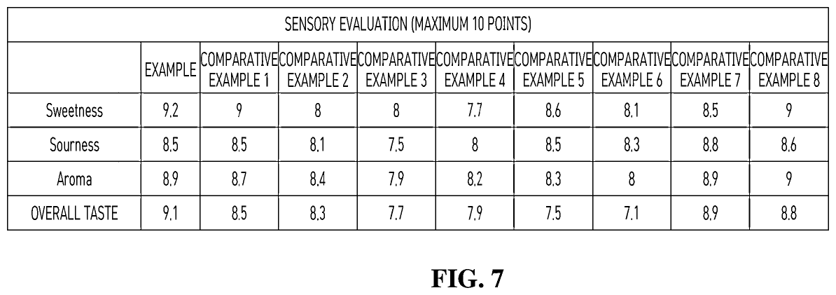

Sensory evaluation of the beverage compositions according to the example and comparative examples was conducted, and the results are shown in the table of FIG. 7. The sensory evaluation was conducted by preparing the beverage compositions according to each example and comparative example, and having the subject group (total of 10 people) consisting of men and women in their 20s and 30s ingest them, and evaluating the sensory properties on a 10-point scale. The sensory properties consisted of sweetness, sourness, aroma, and overall taste, and the closer the score was to 10, the better the properties of each item were, and the lower the score, the worse the properties of each item were.

According to the results, it can be seen that the sensory properties of the beverage composition according to the example was better than those of the beverage compositions according to the comparative examples.

As described above, according to one embodiment of the present invention, a beverage composition for professional athletes, which enables to recover from and reduce muscular fatigue by improving the ability to decompose lactic acid before and after exercise and has improved sensory properties such as taste and ease of intake, can be provided.

In addition, according to one embodiment of the present invention, a functional beverage composition having high mineral content and amino acid content, and excellent antioxidant capacity, exercise ability improving effect, and sensory properties can be provided.

The foregoing description of the present invention has been presented for the purposes of illustration and description. It is apparent to a person having ordinary skill in the art to which the present invention relates that the present invention can be easily modified into other detailed forms without changing the technical principle or essential features of the present invention. Therefore, the foregoing embodiments should be regarded as illustrative rather than limiting in all aspects. In an example, each component which has been described as a unitary part can be implemented as distributed parts. Likewise, each component which has been described as distributed parts can also be implemented as a combined part.

The scope of the present invention is presented by the accompanying claims rather than the foregoing description. It should be understood that all changes or modifications derived from the definitions and scopes of the claims and their equivalents fall within the scope of the present invention.

1. A beverage composition for recovering from and reducing muscular fatigue, comprising 10% to 25% by weight of sugarcane juice, 60% to 90% by weight of natural herbal ingredients, 5% to 15% by weight of functional amino acid ingredients, and the remainder.

2. The beverage composition according to claim 1, wherein the natural herbal ingredients include 30% to 60% by weight of plum extract, 5% to 20% by weight of Schisandra chinensis extract, 5% to 20% by weight of black raspberry extract, and 1% to 5% by weight of red ginseng.

3. The beverage composition according to claim 1, wherein the functional amino acid ingredients include 2% to 7% by weight of branched-chain amino acid (BCAA), 3% to 8% by weight of alanine, and 0.2% to 2% by weight of proline.

4. The beverage composition according to claim 1, wherein the sugarcane juice is prepared by crushing and drying sugarcane and then forming a juice through vacuum depressurization.
